(19) United States
(12) Patent Application Publication
(10) Pub. No.: US 2012/0189820 A1
(43) Pub. Date: Jul. 26, 2012

(54) TEMPERATURE RESPONSIVE GLAZING PLATE

(76) Inventors: Gilad Hakim, Ramat Hashofet (IL); Amos Ophir, Karkur (IL); Gilad Roter, Kiryat Tivon (IL); Avishay Pelah, Kiryat-Ono (IL); Ana Dotan, Ramat-Gan (IL)

(21) Appl. No.: 13/321,585

(22) PCT Filed: May 17, 2010
(86) PCT No.: PCT/IL10/00397

§ 371 Date: Feb. 6, 2012

(30) Foreign Application Priority Data
May 20, 2009 (IL) 198837

(51) Int. Cl. E06B 3/677

(52) U.S. Cl. 428/188

(57) ABSTRACT

A temperature-responsive glazing device includes a transparent structure with at least one chamber. The chamber encloses a temperature-responsive material characterized by a transition temperature, such that the transparency of the device is substantially different for fluid temperatures above and below the transition temperature.

### FIELD OF THE INVENTION

The present invention relates to glazing. More particularly, the present invention relates to a temperature responsive glazing plate

### BACKGROUND OF THE INVENTION

In construction of buildings or other structures, internal lighting is often an important consideration. Often, an effective and energy-efficient way to illuminate the interior of a structure is enable sunlight to penetrate the interior of the building through the roof of the structure. All or part of the roof may be constructed out of a material that transmits light. For example, all or part of the roof may be made out of a transparent or translucent material, or an opaque roof may be provided with a window or skylight.

Illuminating the interior of the structure with sunlight may also heat the structure. In order to maintain the comfort of those inside the structure, the temperature inside the structure may be regulated. Thus, illumination of the interior of a building may be limited in order to avoid overheating the interior of the structure. The optimal balance of illumination and heating may vary with changing weather conditions, season, and time of day. For example, on a cold day, a transparent material may be desirable to provide maximum illumination and maximum heating. On the other hand, when it is midday during warm weather, it may be desirable to limit illumination in order to minimize heating. However, near the beginning or end of the day, more illumination may be preferred.

Various known means for controlling the amount of sunlight transmitted by windows or other transparent construction elements may not always be practical or suitable. For example, shades, blinds, and curtains, or other similar means used to limit the light transmitted through a small window, even when remotely or automatically controlled, may not be suitable for a large, elevated roof or skylight. For example, considerations such as maintenance or esthetics may rule out such solutions.

Photochromic glazing materials have also been used in order to control the transmission through windows. A photochromic material darkens in response to exposure to light, thus reducing the transmission of light through the material. However, glazing panels including photochromic material may not necessarily provide an adequate solution for a roof or skylight. For example, in some climates, cold weather may be accompanied by bright sunlight. Under such circumstances, a photochromic material may darken. However, under such circumstances, it may be preferable to allow sunlight to penetrate into the structure so as to warm the building interior. On the other hand, during warm weather, it may be desirable to limit the transmission of even relatively low levels of light.

Another known way of controlling the transmission of sunlight into a building involves the use of electrochromic glazing. The transmission of light through electrochromic glazing material may vary in response to an electric current through the glazing material. Use of electrochromic glazing to control requires a separate device to actively control the electric current in response to conditions.

It is an object of the present invention, to provide glazing whose transmission properties may be altered passively in order to assist in maintaining optimal illumination and heating conditions of the interior of a building.

Other aims and advantages of the present invention will become apparent after reading the present invention and reviewing the accompanying drawings.

### SUMMARY OF THE INVENTION

There is thus provided, in accordance with some embodiments of the present invention, a temperature-responsive glazing device including a structure of a transparent material including at least one chamber that encloses a temperature-responsive fluid characterized by a transition temperature, such that the transparency of the device is substantially different for fluid temperatures above and below the transition temperature.

Furthermore, in accordance with some embodiments of the present invention, the transparency substantially decreases when the temperature of the fluid increases to above the transition temperature with respect to the transparency of the device when the temperature of the fluid is below the transition temperature.

Furthermore, in accordance with some embodiments of the present invention, the temperature-responsive fluid changes its optical diffusion characteristics at the transition temperature.

Furthermore, in accordance with some embodiments of the present invention, the transparent material is selected from the group of materials consisting of: polycarbonate, polyvinyl chloride (PVC), poly(methyl methacrylate) (PMMA), PET, PETG, polyester, fiberglass, polyolephine, polystyrene, SAN and glass.

Furthermore, in accordance with some embodiments of the present invention, the temperature-responsive fluid includes a water solution of a material selected from a group of materials consisting of: PNIPA, PEG, PVME, and polymerized oligo (ethylene glycol) methacrylate.

Furthermore, in accordance with some embodiments of the present invention, the solution further includes a salt.

Furthermore, in accordance with some embodiments of the present invention, the salt includes sodium sulfate.

Furthermore, in accordance with some embodiments of the present invention, the temperature-responsive material includes a thickening agent.

Furthermore, in accordance with some embodiments of the present invention, the thickening agent includes HEC.

Furthermore, in accordance with some embodiments of the present invention, the temperature-responsive material includes a preservative.

Furthermore, in accordance with some embodiments of the present invention, the preservative includes CIT/MIT.

Furthermore, in accordance with some embodiments of the present invention, the chamber includes a plurality of chambers.

Furthermore, in accordance with some embodiments of the present invention, the chambers include a plurality of substantially parallel longitudinal chambers.

Furthermore, in accordance with some embodiments of the present invention, the structure includes at least two substantially parallel layers.

Furthermore, in accordance with some embodiments of the present invention, at least one layer includes insulating voids.

Furthermore, in accordance with some embodiments of the present invention, the structure includes an interlocking panel.

Furthermore, in accordance with some embodiments of the present invention, the structure includes a structured sheet.

Furthermore, in accordance with some embodiments of the present invention, a wall of the chamber includes an impermeable layer.

Furthermore, in accordance with some embodiments of the present invention, the impermeable layer includes a material selected from a group of materials consisting of: PVDC, biaxially oriented polyester, biaxially oriented polypropylene.

Furthermore, in accordance with some embodiments of the present invention, the impermeable layer is a layer that is coextruded with the transparent structure.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1A is a schematic illustration of transmission of light through a glazing plate in a transparent state, in accordance with embodiments of the present invention.

FIG. 1B is a schematic illustration of scattering of incident radiation by the glazing plate of FIG. 1A, when the plate is in a translucent state.

FIG. 2A shows a glazing plate in accordance with some embodiments of the present invention.

FIG. 2B is a cross section of the glazing plate of FIG. 2A, some of which is filled with temperature-responsive material.

FIG. 3 is a cross section an alternative construction of a glazing plate in accordance with embodiments of the present invention, illustrating filling the plate with temperature-responsive material.

FIG. 4 is a cross section of a glazing plate including temperature-responsive capsules, in accordance with embodiments of the present invention.

FIG. 5A is a cross section of a glazing plate in the form of an interlocking panel, in accordance with embodiments of the present invention.

FIG. 5B is a cross section of a variation of a glazing plate in the form of a panel, in accordance with embodiments of the present invention.

### DETAILED DESCRIPTION OF EMBODIMENTS

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

A glazing plate in accordance with embodiments of the present invention includes a temperature-responsive material. A material is temperature-responsive material if one or more properties of the material are designed to change in response to a change in temperature. In the case of a temperature-responsive glazing plate in accordance with embodiments of the present invention, the optical transmission properties of the component material of the plate may change in response to a change in temperature. For example, a component material may be transparent at one temperature, and translucent at another. A transparent material is understood to include a material that at least partially transmits light, such as sunlight or any other radiation of interest, and may include materials that transmit a fraction of incident light, or that color, distort, partially absorb, partially reflect, or partially scatter, transmitted light. A translucent material may diffuse a significant portion of light that penetrates the material, such that light is transmitted by the material, but no clear image may be formed through the material.

For example, a component temperature-responsive material of the glazing plate may be substantially transparent at a lower temperature. When the temperature-responsive material is heated above a transition temperature, the component material may then form particles that are capable of scattering light. Depending on the density of the scattering particles, the material may then scatter all or some of the incident light, diffusing the light. For example, sunlight may be incident on an outer surface of a glazing plate. An inner surface of the plate faces the interior of a structure. A fraction of light incident on an outer surface of the plate may be transmitted without scattering to an inner surface of the material, and to the interior of the structure. Another fraction of the incident light may be scattered or diffused. Of the diffused light, some may exit back out through the outer surface, some may emerge from the inner surface into the interior of the structure, and some may be absorbed. If a sufficient fraction of the incident light is diffused, and not transmitted directly to the inner surface, the material may appear translucent. Light that diffuses back out through the outer surface does not penetrate to the interior of the structure. Thus, when the glazing material is translucent, the effective reflectivity of the glazing plate may increase, and less light may be transmitted to the interior of the structure than when the material is transparent. Effective reflectivity of the glazing plate refers to the fraction of incident light on one side that is returned backward through or from that same side of the plate, whether due to specular or diffuse reflection from one or more surfaces on or within the plate, due to scattering within the plate, or due to sequential reflection or refraction from a plurality of interfaces within the plate.

A glazing plate that incorporates the temperature-responsive material may be installed in the outer enclosure of a building or structure. Typically, the glazing plate may be installed as part of a roof or skylight of the structure. Such a plate may also be installed as part of a wall, partition, or window.

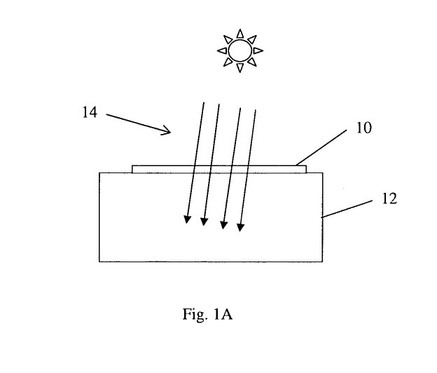

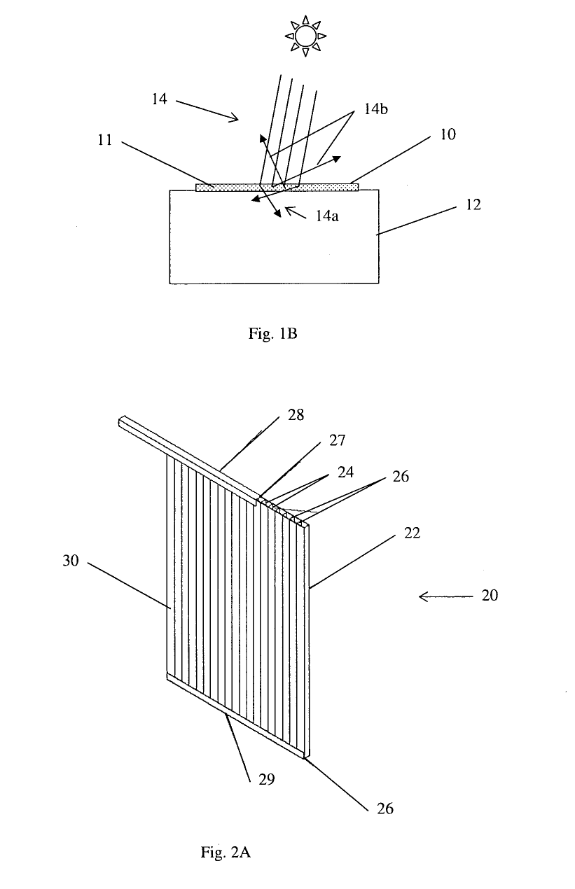

FIG. 1A is a schematic illustration of transmission of light by a glazing plate in a transparent state, in accordance with embodiments of the present invention. Glazing plate 10 is built into a wall of structure 12. Light, for example sunlight, represented by rays 14, is incident on the outer surface of glazing plate 10. When in a transparent state, glazing plate 10 transmits rays 14, into the interior of structure 12. FIG. 1B is a schematic illustration of scattering of incident radiation by a plate as in FIG. 1A, when the plate is in a translucent state. Again, rays 14 are incident on the outer surface of transparent glazing plate 10. When in a translucent state, glazing plate 10 includes scatterers 11. Scatterers 11 may scatter incident light in a random manner. For example, rays 14a emerge from the interior surface of glazing plate 10, entering structure 12. On the other hand, rays 14b are scattered back through the exterior surface of glazing plate 10. Thus, the transmitted fraction of the incident radiation represented by rays 14a may illuminate the interior of structure 12, while the returned fraction represented by rays 14b does not.

The temperature-responsive material may be selected so that the transition temperature of the material is close to a temperature limit selected on the basis of design considerations. For example, the glazing plate may be installed in the roof of a building or structure. The temperature limit may then be based on, for example, a maximum temperature above which use of the building or structure becomes uncomfortable. When installed in the roof of a structure in which the temperature near the roof is expected to be higher than in the inhabited part of the structure, the transition temperature may be selected to be somewhat higher than the maximum comfortable temperature. In this manner, when the temperature of the glazing panel increases to a temperature equal to, or greater than, the transition temperature, the glazing panel may begin to diffuse incident sunlight. Diffusing the incident sunlight may then prevent or retard further heating of the building. During cold weather, on the other hand, the temperature of the glazing panel may not increase to the transition temperature even when exposed to direct sunlight. Thus, a glazing panel in accordance with embodiments of the present invention may be designed to transmit sunlight when heating is desirable or not objectionable, and to partially block sunlight when heating of the interior is not desired.

The temperature-responsive material may be in the form of a material that is encased in the glazing plate. For example, a glazing plate may be in the form of a casing, at least part of which is hollow. The casing may be a transparent structure that is constructed at least partially of a transparent, or partially transparent, material. A transparent material is understood to include a material that at least partially transmits light, such as sunlight or any other radiation of interest, and may include materials that transmit a fraction of incident light, or that color, distort, partially absorb, partially reflect, or partially scatter, transmitted light. A transparent structure is to be understood as including at least a component (such as a window or skylight) that is constructed with transparent material, even when the component of transparent material is shaped or constructed so as to distort transmitted light such that no image may be formed through the plate. Suitable casing materials may include, for example, polycarbonate, polyvinyl chloride (PVC), poly(methyl methacrylate) (PMMA), polyethylene terephthalate (PET and PETG), polyester, fiberglass, polyolephine, polystyrene, styrene acrylonitrile (SAN), and glass. The casing may be constructed in the form of a panel or sheet, such that its lateral dimensions are larger than its thickness. For example, a casing may be constructed in the form of a double-paned window, with two parallel panes of casing material held together by means of a frame. A flat hollow interior cavity is thus formed between the panes. As another example, a hollow interior of the casing may be divided by internal partitions, walls, or ribs into a plurality of hollow cavities or chambers. For example, the casing may be divided by internal partitions into elongated parallel chambers with rectangular or triangular cross sections. Internal partitions may serve to increase the mechanical strength of the casing.

One or more hollow sections of the casing may be filled with a temperature-responsive material. The material may be in the form of a fluid, liquid solution, hydrogel, gel, liquid crystal, or a powder or other granulated solid. An example of a temperature-responsive liquid is a solution of poly(N-isopropylacrylamide)-based polymers in water. (Poly(N-isopropylacrylamide) is variously abbreviated as PNIPA or PNIPAM.) When heated above its transition temperature, approximately 32° C. to 34° C., a PNIPA solution may scatter light. Various materials may be added to the solution in order to control the characteristics of the solution. For example, materials may be added to lower the melting point of the solution so as to prevent freezing. Additives to the solution may inhibit the growth of algae, bacteria, or other organisms, or may add color to the solution. Various salts added to the solution, such as, for example, sodium sulfate, may significantly lower the transition temperature. Control of the transition temperature may be achieved by other means as well. For example, incorporating hydrophobic monomers during synthesis of PNIPA may lower the transition temperature, while incorporating hydrophilic monomers may raise it. Other temperature-responsive fluids may include, for example, water solutions of polymers and thermotropic materials such as poly(ethylene glycol) (PEG), poly(oxazoline), poly(vinyl methyl ether) (PVME), and various non-linear analogs of PEG such as polymerized oligo (ethylene glycol) methacrylates.

The hollow sections of the casing may be designed so as to preserve the integrity of the temperature-responsive material. For example, the walls of the hollow sections may be designed to prevent outward seepage or diffusion of one or more components of the temperature-responsive material. For example, the walls may be constructed of a material that is permeable to one or more components, such as a solvent, of the temperature-responsive material. For example, a polycarbonate material may be permeable to diffusion of water through the material. As another example, the walls may be coated with a material that is impermeable to the component. For example, a chamber wall may be formed by coextrusion of the wall material with the impermeable material. For example, a chamber wall may be formed by coextrusion of a polycarbonate wall material with a material that is impermeable to water, such as, for example, polyvinylidene chloride (PVDC), biaxially oriented polyester, or biaxially oriented polypropylene.

A temperature-responsive fluid in accordance with embodiments of the present invention may include a thickening agent as an additive. For example, a thickening agent may be added to a temperature-responsive fluid that includes a solution of polymer in a solvent such as water. For example, a thickening agent containing hydroxyethyl cellulose (HEC) may be added to a water solution as a thickening agent. An example of such a thickening agent is Tylose® H 100000 YP2. Addition of the thickening agent may inhibit phase separation or precipitation of the polymer out of the solution. Addition of the thickening agent may also increase the viscosity of the solution and may inhibit diffusion or seepage of a component of the solution through the chamber walls.

A temperature-responsive fluid in accordance with embodiments of the present invention may include a preservative. A preservative may include a biocide for preventing one or more organisms from degrading the fluid. For example, a temperature-responsive fluid may include a preservative containing 5-chloro-2-methyl-4-isothiazolin-3-one and 2-methyl-4-isothiazolin-3-one (CIT/MIT). An example of such a preservative is Acticide® F(N).

For example, a temperature-responsive fluid may include a water solution that includes: 1% concentration of an active material (e.g. PVME), 1.7% concentration of a HEC-based thickening agent (originally in powder form), 0.2% concentration of a CIT/MIT-based preservative, and 0.04% concentration of a 25% ammonia solution (for activating the thickening agent). Solutes may poured into the water slowly and while stirring in order to minimize clumping. After addition of the ammonia, stirring may be stopped in order to prevent trapping of bubbles as the solution becomes more viscous.

Alternatively, a temperature-responsive capsule may be provided in which a temperature-responsive fluid is encapsulated by a transparent material. To make such a capsule, for example, a hollow capsule may be made of a suitable transparent material, such as, for example, acrylate. The hollow capsule may be filled with temperature-responsive fluid via an opening that is sealed after filling. Alternatively, a mass of temperature-responsive fluid in a solid or viscous frozen state may be coated with a transparent encapsulating material. When the temperature-responsive mass melts into a liquid, the liquid is enclosed by the encapsulating coating.

The size of the capsules may be designed such that a plurality of such capsules may fit inside at least one of the hollow sections of casing. One or more hollow sections of the casing may be filled with such temperature-responsive capsules.

The capsules filling a section of the casing may be bonded to one another. For example, the capsules may be coated with, or surrounded by, an adhesive material, or may be surrounded by a fluid that hardens to a transparent, solid state. For example, an adhesive may be heat activated, or may be activated or cured by other means. When the adhesive is activated or cured, the capsules bond and adhere to one another. In this manner, the capsules may remain in place when not completely enclosed by the casing. For example, if the casing is cut or opened at a construction site, the temperature-responsive material filling the casing may not be lost. Alternatively, a mold or other temporary support structure may be filled with capsules that are made to bond to one another. When removed from the mold, the bonded capsules may form a temperature-responsive glazing plate that may not require a casing to provide mechanical support.

One or more hollow sections of the casing may remain filled with air or another gas, or may be evacuated. Such hollow sections may act as insulating voids. An insulating void may inhibit the conductive or convective transfer of heat across the void.

A glazing plate in accordance with embodiments of the present invention may be designed for incorporation in the construction of a building or structure. For example, a glazing plate may be manufactured in the form of a panel designed to interlock with similar panels. In general, for a panel to be compatible with other similar panels, the panel may be manufactured in one of a limited variety of fixed sizes. One or more edges of the panel may be provided with structure that enables the panel to interlock with a similar panel. For example, the structure may be in the form of a male projection at an edge of a panel that is designed to mate with a corresponding female indentation on another panel. Alternatively, the edge may be provided with a projection that is designed to interlock with, or nest inside of, a similarly shaped projection on another panel. Alternatively, both panels may be provided with extensions which may be coupled to one another by means of an appropriately shaped coupling element. For example, each panel may be provided with a bent extension along its edge. When two such panels are placed adjacent to one another, a coupling element in the form of an elongated channel may fit over the two extensions so as to hold them together.

Alternatively, a glazing plate may be manufactured in the form of a structured sheet. Standard (not temperature-responsive) structured sheets are generally manufactured in standard sizes that may cut as needed at a construction site. One or more dimensions of the structured sheet may be limited to a maximum size by a manufacturing process, such as, for example, extrusion. The structured sheet may be provided with a protective or decorative frame or rim around all or part of its edges. The frame may be added at the construction site, after the structured sheet is cut. A structured sheet may be held in the roof or wall of a building or structure by a suitable framework or element for holding structured sheets together, as is known in the art. In the case of a structured sheet filled with temperature-responsive liquid material, filling may take place at a plant where the sheet is manufactured. In this case, sheets with temperature-responsive material may be made to order in a manufacturing so as to provide customized sheet sizes. Alternatively, the sheet may be filled with a highly viscous temperature-responsive material, such as a gel, such that when cut, a sufficient amount of the material may remain in place until re-enclosed, for example, by a sealant or frame. Alternatively, the sheet may include bonded temperature-responsive capsules, such that the sheet may be cut without significant loss of temperature-responsive material. Alternatively, appropriately trained and equipped personnel may cut an unfilled sheet to size at a construction site, fill the sheet with temperature-responsive material, and seal the temperature-responsive material, all on site.

FIG. 2A shows a glazing plate in accordance with some embodiments of the present invention. Glazing plate 20 includes fluid enclosure 22. Fluid enclosure 22 may be similar in construction to a standard glazing panel or sheet. Outer walls 30 of fluid enclosure 22 may be constructed from a transparent material. A suitable transparent material for the construction of outer walls 30 may include, for example, polycarbonate. Fluid enclosure 22 may be divided by internal partitions 26 into chambers 24. All or some of chambers 24 may be filled with a temperature-responsive fluid. Dividing fluid enclosure 22 into chambers 24 by means of internal partitions 26 may provide increased mechanical strength to the enclosure. Thus, a divided enclosure may be capable of holding more fluid than an undivided chamber.

FIG. 2B is a cross section of the glazing plate of FIG. 2A, illustrating the glazing plate partially filled with temperature-responsive material, whereas the remainder of chambers 24 does not contain temperature-responsive material. Chambers 32 have been filled with temperature-responsive fluid. In other embodiments of the present invention some or all of the remainder of chambers 24 may also be filled with temperature-responsive fluid.

Referring back to FIG. 2A, once the material has been introduced into chambers 24, fluid enclosure 22 with chambers 24 may be sealed. For example, in some embodiments of the current invention, an end of fluid enclosure 22, for example, bottom end 29 of fluid enclosure 22, may be sealed with a suitable sealant, such as silicone. One end of fluid enclosure 22 remains open, such as the top end 27 of fluid enclosure 22, while other sides of fluid enclosure 22 are enclosed by outer walls 30. Temperature-responsive fluid may then be introduced into one or more of chambers 24 through open top end 27. After introducing temperature-responsive fluid into chambers 24, top end 27 may be sealed with a sealant, enclosed by a enclosing structure such profile 28, or both. Profile 28 may be constructed of a metal such as aluminum, or of a plastic such as polycarbonate.

Alternatively, a hole or opening through which the material was introduced into enclosure 22, or one or more of chambers 24, may be sealed with a sealant material, such as silicone. Alternatively, heat may be applied to an opening or open end of enclosure 22, or of one or more chambers 24, so as to weld or fuse it shut.

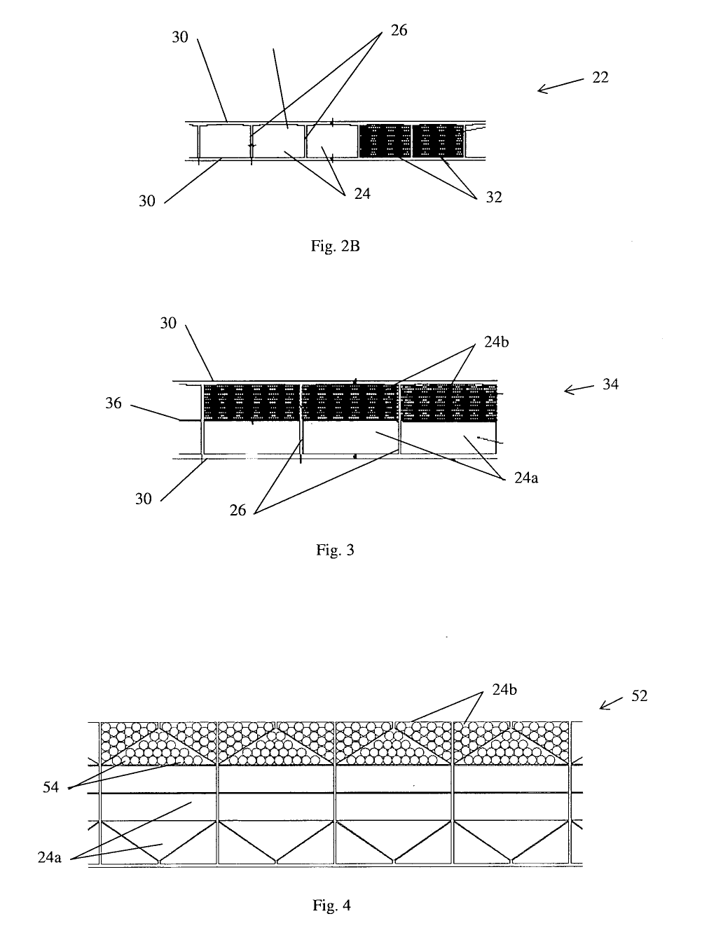

FIG. 3 is a cross section an alternative construction of a glazing plate in accordance with some embodiments of the present invention, illustrating filling the plate with temperature-responsive material. Dual layer enclosure 34 includes internal wall 36. Internal wall 36 divides the chambers into two layers (sets of chambers), lower chambers 24a, and upper chambers 24b. As shown in FIG. 3, upper chambers 24b are filled with temperature-responsive fluid. Lower chambers 24a remain filled with air. Air-filled lower chambers 24a may provide thermal insulation in the form of insulating voids between the interior and exterior of the structure.

One or more chambers of a glazing plate may be filled with temperature-responsive capsules. FIG. 4 is a cross section of a glazing plate including temperature-responsive capsules, in accordance with some embodiments of the present invention. Glazing plate 52 includes chambers 24b that are filled with temperature-responsive capsules 54. Other chambers 24a may be left empty or may be filled with another temperature-responsive material. Although temperature-responsive capsules 54 are depicted as round or spherical, the capsules may be of any shape suitable for use in filling a chamber 24a. Temperature-responsive capsules 54 may be bonded to one another by means of a suitable bonding technique.

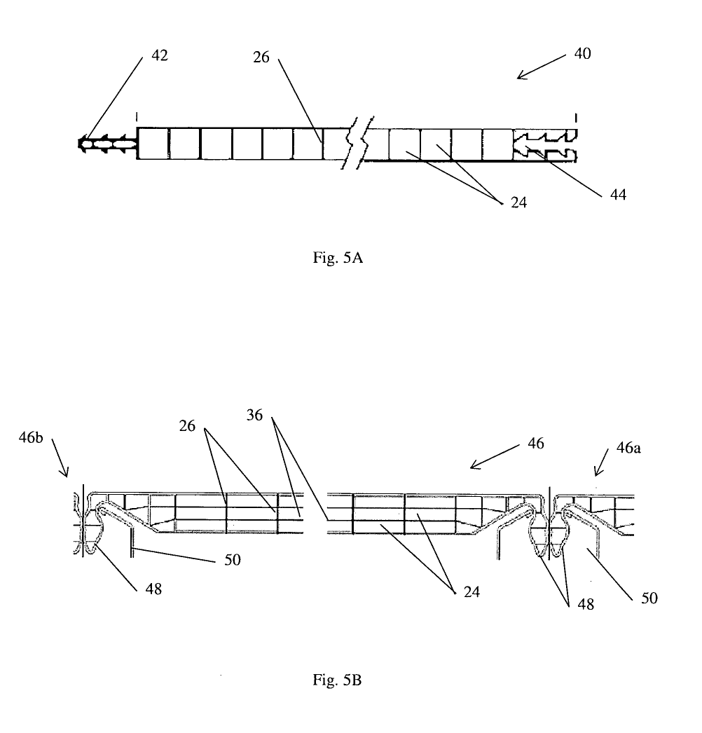

When the glazing plate is in the form of a panel, the panel is provided with structure for attaching panels to each other. FIG. 5A is a cross section of a glazing plate in the form of an interlocking panel, in accordance with some embodiments of the present invention. An interlocking panel 40 is provided with male projection 42 projecting from at least one edge of interlocking panel 40. At least one edge of interlocking panel 40 is provided with female indentation 44. Male projection 42 of one interlocking panel 40 may be inserted into a corresponding female indentation 44 of a similar interlocking panel 40, locking the panels together.

FIG. 5B is a cross section of a variation of a glazing plate in the form of a panel, in accordance with some embodiments of the present invention. Edges of panel 46 are provided with knobbed projections 48. When edges of similar panels 46a and 46b are placed against edges of panel 46, knobbed projections 48 abut one another. Locking profiles 50 may fit over knobbed projections 48, locking the panels together.

Thus, embodiments of the present invention provide for a panel whose transmission of light is passively controlled by the temperature of the panel.

It should be clear that the description of the embodiments and attached Figures set forth in this specification serves only for a better understanding of the invention, without limiting its scope.

It should also be clear that a person skilled in the art, after reading the present specification could make adjustments or amendments to the attached Figures and above described embodiments that would still be covered by the present invention.

1. A temperature-responsive glazing device comprising a transparent structure including at least one chamber that encloses a temperature-responsive material characterized by a transition temperature, such that the transparency of the device is substantially different for fluid temperatures above and below the transition temperature.

2. A device as claimed in claim 1, wherein the temperature-responsive material is designed to respond to an increase in temperature above the transition temperature by decreasing the transparency of the material with respect to the transparency of the material at a temperature below the transition temperature.

3. A device as claimed in claim 1, wherein the temperature-responsive material changes its optical diffusion characteristics at the transition temperature.

4. A device as claimed in claim 1, wherein the transparent structure comprises material selected from the group of materials consisting of: polycarbonate, PVC, PMMA, PET, PETG, polyester, fiberglass, polyolephine, polystyrene, SAN and glass.

5. A device as claimed in claim 1, wherein the temperature-responsive material comprises a water solution of a material selected from a group of materials consisting of: PNIPA, PEG, PVME, and polymerized oligo (ethylene glycol) methacrylate.

6. A device as claimed in claim 5, wherein the solution comprises a salt.

7. A device as claimed in claim 6, wherein the salt comprises sodium sulfate.

8. A device as claimed in claim 1, wherein the temperature-responsive material comprises a thickening agent.

9. A device as claimed in claim 8, wherein the thickening agent comprises HEC.

10. A device as claimed in claim 1, wherein the temperature-responsive material comprises a preservative.

11. A device as claimed in claim 10, wherein the preservative comprises CIT/MIT.

12. A device as claimed in claim 1, wherein said at least one chamber comprises a plurality of chambers.

13. A device as claimed in claim 12, wherein said plurality of chambers comprises a plurality of substantially parallel longitudinal chambers.

14. A device as claimed in claim 1, wherein said structure comprises at least two substantially parallel layers.

15. A device as claimed in claim 14, wherein at least one layer is an insulating layer

16. A device as claimed in claim 15, wherein the insulating layer includes insulating voids.

17. A device as claimed in claim 1, wherein the structure comprises an interlocking panel.

18. A device as claimed in claim 1, wherein the structure comprises a structured sheet.

19. A device as claimed in claim 1, wherein the temperature-responsive material is encapsulated in a plurality of capsules.

20. A device as claimed in claim 19, wherein capsules of the plurality of capsules are bonded to one another.

21. A device as claimed in claim 19, wherein the plurality of capsules include transparent encapsulating material.

22. A device as claimed in claim 1, wherein a wall of said at least one chamber comprises an impermeable layer.

23. A device as claimed in claim 22, wherein the impermeable layer comprises a material selected from a group of materials consisting of: PVDC, biaxially oriented polyester, biaxially oriented polypropylene.

24. A device as claimed in claim 22, wherein the impermeable layer is a layer that is coextruded with the transparent structure.
